(19) United States
(12) Patent Application Publication
(10) Pub. No.: US 2025/0007297 A1
(43) Pub. Date: Jan. 2, 2025

(54) CONTROL DEVICE, POWER SUPPLY SYSTEM, CONTROL METHOD, AND NON-TRANSITORY COMPUTER READABLE STORAGE MEDIUM

(71) Applicant: HONDA MOTOR CO., LTD., Tokyo (JP)

(72) Inventors: Yasuhiro NAKADA, Wako-shi (JP); Takayuki ENOMOTO, Wako-shi (JP)

(21) Appl. No.: 18/884,650

(22) Filed: Sep. 13, 2024

Related U.S. Application Data
(63) Continuation of application No. PCT/JP2022/012348, filed on Mar. 17, 2022.

(51) Int. Cl. H02J 3/46; H02J 13/00

(52) U.S. Cl. CPC H02J 3/46; H02J 13/00006; H02J 2203/10; H02J 2300/24

(57) ABSTRACT

A control device capable of communicating with a plurality of distributed power sources in a power supply system that supplies electric power to a demander, the control device performs: acquiring capability information regarding a capability of power supply of a first distributed power source and supply power information regarding a power amount being supplied by the first distributed power source from the first distributed power source out of the plurality of distributed power sources; determining a target value of electric power supplied by the first distributed power source on the basis of the acquired capability information; and controlling electric power supplied by the first distributed power source on the basis of the determined target value and the acquired supply power information.

### CROSS-REFERENCE TO RELATED APPLICATION(S)

This application is a continuation of International Patent Application No. PCT/JP2022/012348 filed on Mar. 17, 2022, the entire disclosures of which are incorporated herein by reference.

### BACKGROUND OF THE INVENTION

### Field of the Invention

The present invention relates to a control device that controls supply power of power supply devices arranged in a distributed manner, a power supply system, a control method, and a non-transitory computer readable storage medium.

### Description of the Related Art

Japanese Patent Laid-Open No. 2008-253002 discloses a power supply system that supplies electric power by a plurality of power supply devices in cooperation with one another. Japanese Patent Laid-Open No. 2008-253002 discloses acquiring power specification information regarding supply power of a plurality of power devices and controlling an output state of electric power to be supplied to a load device on the basis of the acquired power specification information.

In such power supply system, power supply devices having different capabilities of power supply are connected, so that it is necessary to appropriately control a load of the power supply device according to the capability of power supply of the power supply device so that a high load is not applied to the power supply device having a low capability of power supply.

### SUMMARY OF THE INVENTION

The present invention is to provide a technology of controlling power supply of a power supply device according to a load of the power supply device.

According to the present invention, a control device, capable of communicating with a plurality of distributed power sources in a power supply system that supplies electric power to a demander, comprises: at least one processor; and at least one memory storing instructions that, when executed by the at least one processor, cause the at least one processor to function as: an acquisition unit configured to acquire capability information regarding a capability of power supply of a first distributed power source and supply power information regarding a power amount being supplied by the first distributed power source from the first distributed power source out of the plurality of distributed power sources; a determination unit configured to determine a target value of electric power supplied by the first distributed power source on the basis of the capability information acquired by the acquisition unit; and a control unit configured to control electric power supplied by the first distributed power source on the basis of the target value determined by the determination unit and the supply power information acquired by the acquisition unit.

According to the present invention, it is possible to provide a technology of controlling power supply of a power supply device according to a load of the power supply device.

Further features of the present invention will become apparent from the following description of exemplary embodiments (with reference to the attached drawings).

### BRIEF DESCRIPTION OF THE DRAWINGS

FIG. 1 is a configuration diagram of a power supply system of this embodiment;

FIG. 2 is a flow diagram illustrating an example of processing executed by a control device;

FIG. 3 is a diagram illustrating a correspondence relationship between a conventional load and an output voltage;

FIG. 4 is a diagram illustrating a correspondence relationship between a load and an output voltage; and

FIG. 5 is a diagram illustrating information of a power supply device managed by the control device.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

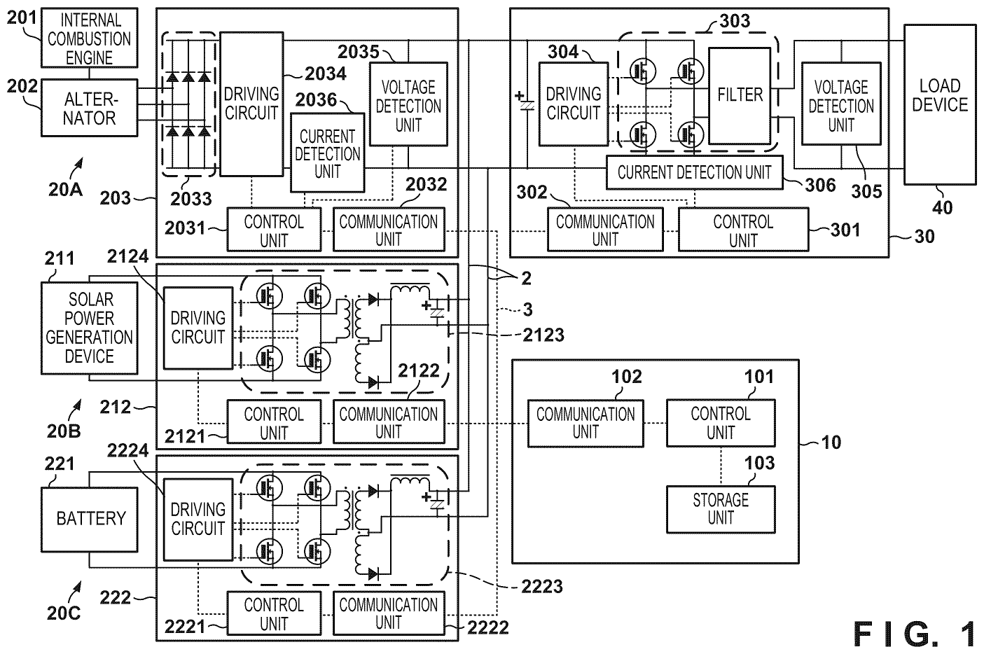

FIG. 1 is a diagram illustrating a power supply system according to this embodiment. A power supply system 1 includes a control device 10, power supply devices 20A to 20C (hereinafter, sometimes referred to as the power supply device 20 without distinction), an inverter 30, and a load device 40. The control device 10, the power supply device 20, and the inverter 30 are connected to one another by a power line 2 so as to be able to transmit and receive electric power. At least the control device 10, the power supply device 20, and the inverter 30 are connected to one another so as to be able to communicate with one another by a network 3. The network 3 is a network including at least either of a local network and a wide-area network. In one example, the network 3 may include the Internet.

In this example, the power line 2 is described as a power network that supplies electric power independently of a wide-area power supply network such as a microgrid. However, the power line 2 may be a part of an on-grid power network connected to the wide-area power supply network. In this case, the power line 2 may be connected to a converter that connects to the wide-area power supply network.

The control device 10 controls supply power of the power supply device 20 connected to the power line 2. The control device 10 includes a control unit 101, a communication unit 102, and a storage unit 103. The control unit 101 controls the electric power supplied by the power supply device 20 according to a power supply status received from the power supply device 20 via the communication unit 102. The control unit 101 includes a processor such as a central processing unit (CPU) and a memory, and executes a control method for controlling the supply power to be described later by executing a program stored in the memory. The communication unit 102 includes a wired or wireless communication interface and includes a communication circuit that communicates with the power supply device 20 via the network 3. The storage unit 103 is a storage device that stores profile information and supply power information transmitted from the power supply device 20 described later. In one example, the control device 10 is a computer including a communication interface.

The power supply device 20 is an example of a distributed power source capable of supplying electric power by communicating with the control device 10 when connected to the power line 2.

The power supply device 20A includes, for example, an internal combustion engine 201 driven using fuel such as light oil, gasoline, or hydrogen gas, an alternator 202 that converts power of the internal combustion engine 201 into electric power, and a rectifying step-down unit 203 that performs power supply of a predetermined voltage from the electric power output from the alternator 202. The rectifying step-down unit 203 includes a control unit 2031, a communication unit 2032, a rectifying step-down circuit 2033, a drive circuit 2034, a voltage detection unit 2035, and a current detection unit 2036.

In this embodiment, the alternator 202 performs three-phase AC output.

Therefore, in the example of FIG. 1, the rectifying step-down unit 203 is illustrated as having a function as a converter that diode-rectifies electric power output from a three-phase line.

The control unit 2031 controls an output voltage by controlling the drive circuit 2034 on the basis of a control signal received from the control device 10 via the communication unit 2032. The communication unit 2032 is a communication circuit that performs wired communication or wireless communication with the control device 10. In one example, the rectifying step-down unit 203 may include an interface for connecting to the network 3 capable of communicating with the control device 10 in the interface with the power line 2. Although the power line 2 is illustrated as being separated from the network 3 in the example of FIG. 1, the communication unit 2032 may communicate with the control device 10 by power line communication (PLC) via the power line 2, and in this case, the power line 2 may function as the network 3.

The rectifying step-down circuit 2033 is a three-phase AC/DC conversion circuit, includes a reverse blocking diode in the example of FIG. 1, and converts AC into DC by outputting an input of a high voltage out of three-phase AC input. Note that, a circuit having a different structure may be applied to the rectifying step-down circuit 2033. For example, in a case where the output of the alternator 202 is not AC power but DC power, a structure may be similar to that of rectifying step-down circuits 2123 and 2223 to be described later.

The drive circuit 2034 is a circuit for controlling the output of the rectifying step-down circuit 2033. For example, the drive circuit 2034 includes a variable resistance and controls a voltage of the output of the rectifying step-down circuit 2033. The drive circuit 2034 controls a resistance value of the variable resistance on the basis of the control signal received from the control unit 2031.

The voltage detection unit 2035 measures the output voltage and notifies the control unit 2031 of a measurement value indicating the output voltage. The current detection unit 2036 measures an output current and notifies the control unit 2031 of a measurement value indicating the output current. The control unit 2031 transmits the notified output voltage value and output current value to the control device 10 via the communication unit 2032.

The power supply device 20B includes, for example, a solar power generation device 211 such as a solar panel, and a DC-DC converter 212 that converts DC power output from the solar power generation device 211 into a predetermined voltage. The DC-DC converter 212 includes a control unit 2121, a communication unit 2122, the rectifying step-down circuit 2123, and a drive circuit 2124.

The control unit 2121 controls the output voltage by controlling the drive circuit 2124 on the basis of the control signal received from the control device 10 via the communication unit 2122. The control unit 2121 includes a processor such as a central processing unit (CPU) and a memory, and controls the drive circuit 2124 by executing a program stored in the memory. Since the communication unit 2122 is similar to the communication unit 2032, the description thereof is omitted. Although the rectifying step-down circuit 2123 illustrated in FIG. 1 is described as a full-bridge type insulated DC-DC converter, other DC-DC converter circuits can be applied. The drive circuit 2124 controls an on-off pattern of a signal applied to a gate of a MOSFET transistor of the rectifying step-down circuit 2123.

The power supply device 20C includes a battery 221 and a DC-DC converter 222 that converts DC power output from the battery 221 into a predetermined voltage.

The battery 221 includes any type of battery such as a lead storage battery, a lithium-ion battery, a nickel-hydrogen battery, a nickel-cadmium battery, or an all-solid-state battery. In this embodiment, the battery 221 is described as a secondary battery capable of charging and discharging, but may include a primary battery. Since the DC-DC converter 222 is similar to the DC-DC converter 212, the description thereof is omitted.

Note that, the DC-DC converters 212 and 222 may include a voltage detection unit that detects a voltage of the supply power and a current detection unit that detects a current value.

The inverter 30 includes a control unit 301, a communication unit 302, a conversion circuit 303, a drive circuit 304, a voltage detection unit 305, and a current detection unit 306.

The control unit 301 converts DC power supplied from the power supply device 20 into AC power on the basis of the control signal received from the control device 10 via the communication unit 302. The control unit 301 includes a processor such as a central processing unit (CPU) and a memory, and controls an operation of the inverter 30 by executing a program stored in the memory. Since the communication unit 302 is similar to the communication unit 2032, the description thereof is omitted. The conversion circuit 303 converts DC power supplied via the power line 2 into AC power. In this embodiment, it is described assuming that the conversion circuit 303 is a full-bridge type inverter, but a conversion circuit having other structures may be applied. Since the voltage detection unit 305 and the current detection unit 306 are similar to the voltage detection unit 2035 and the current detection unit 2036, respectively, description thereof is omitted.

The load device 40 is a demander device that operates by electric power supplied from the inverter 30.

Note that, in this embodiment, it is described assuming that three power supply devices 20 and one load device 40 are connected to a power system, but the number of power supply devices 20 and the number of load device 40 are not limited thereto. A plurality of inverters 30 may be connected to the power line 2, and one or more load devices 40 may be connected to each inverter 30.

### <Autonomous Control Example>

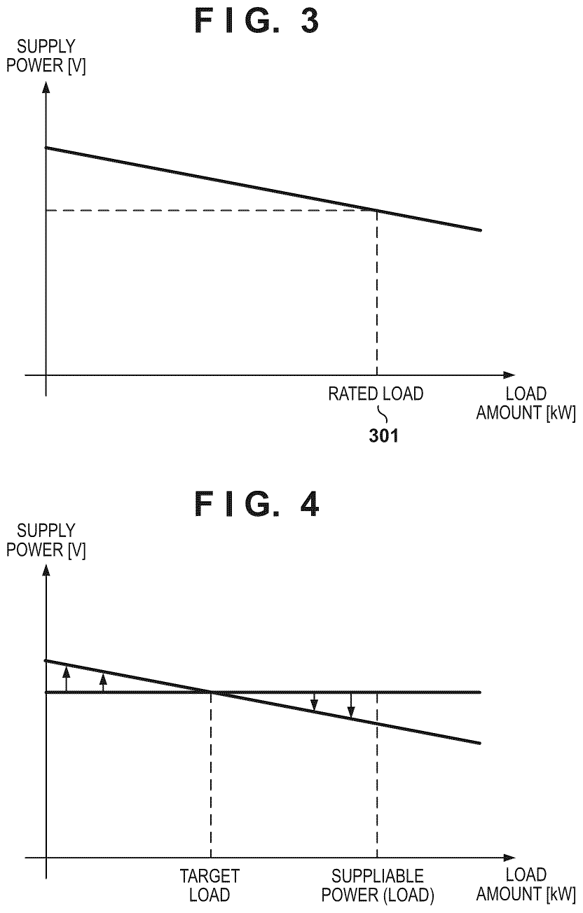

A supply power control method of a conventional power supply device is described with reference to FIG. 3.

Conventionally, each power supply device autonomously performs voltage control for the purpose of supplying electric power with a rated load. In such a case, as illustrated in FIG. 3, the power supply device sets a lowered supply voltage in a case where a load is large with respect to a rated load L3. As a result, since a relative supply voltage is lowered as compared with other power supply devices, it can be expected that the load is lowered. In a case where a power amount currently provided is small with respect to the rated load L3, that is, in a case where the load is small, an increased supply voltage is set. As a result, a relative supply voltage is raised as compared with other power supply devices, so that it can be expected that the load is increased. Even with the power supply device determined to perform power supply at the same rated voltage, a difference in voltage to be supplied might occur between the devices in some cases; and in such a case, a load is unevenly applied to one power supply device, and deterioration in power supply efficiency, heat generation and the like might occur. Therefore, by autonomously adjusting the supply power from the rated voltage, the difference in voltage between the power supply devices can be adjusted.

By such autonomous control, the conventional power supply device controls the voltage so as to perform power supply with the rated load L3. However, in a case where the power amount supplied from the power supply device decreases due to fluctuation in power amount required by the load device 40 and the like, the power supply device performs power supply with a small current amount at a high voltage due to a small load.

When power supply with a small current amount is performed at high voltage in this manner, a switching loss of the inverter 30 increases, the power amount that can be supplied by the power supply system might decrease, and heat generation in a switching power source of the inverter 30 might cause a problem.

### <Control Example of Control Device 10>

The control device 10 according to this embodiment distributes the load according to capability of each power supply device 20, and in a case where there is a difference between the distributed load and the supplied power amount, controls the power amount to be supplied so as to decrease the difference. As a result, since each power supply device 20 can supply electric power at a lower voltage with a lower load, a problem such as heat generation in the switching circuit of the inverter 30 and the like can be solved.

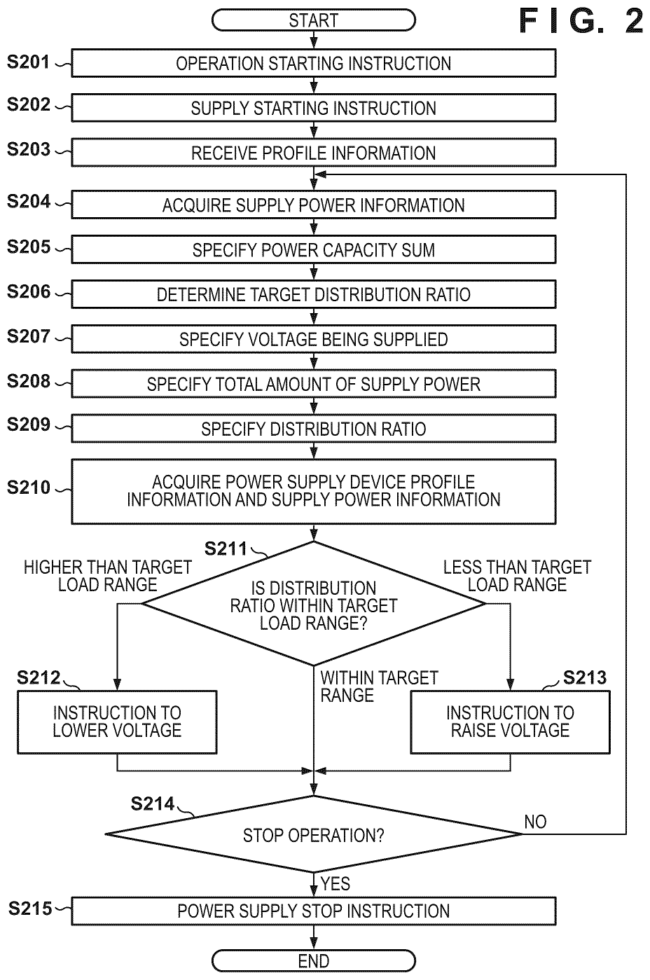

FIG. 2 illustrates a flow of processing executed by the control device 10 according to this embodiment. The processing illustrated in FIG. 2 is implemented by the processor of the control unit 101 of the control device 10 executing the program stored in the memory at a predetermined timing such as when the control device 10 is activated.

At S201, the control device 10 transmits an operation starting instruction to each power supply device 20 connected to the network 3. For example, the power supply device 20A starts a generator on the basis of a received operation instruction. The power supply device 20 that receives the operation starting instruction operates a drive unit until a predetermined voltage value determined in advance in the power supply system 1 is implemented.

At S202, the power supply device 20 instructs the inverter 30 to start power supply from the power supply system 1. As a result, the inverter 30 controls the drive circuit 304 to start supplying electric power to the load device 40.

At S203, the control device 10 receives the profile information of the power supply device 20 from the power supply device 20. The profile information includes an identifier of the power supply device 20, a type (device type) of the power supply device 20, and a power capacity that can be supplied (rated capacity) [kW]. In this processing example, the following description is given assuming that the power supply device 20A has a rated capacity of 5 kW, the power supply device 20B has a rated capacity of 4 kW, and the power supply device 20C has a rated capacity of 1 kW.

Note that, in this embodiment, it is described assuming that the control device 10 acquires the power capacity that can be supplied by the power supply device 20, that is, capability information indicating capability of power supply of the power supply device 20 from the profile information transmitted from the power supply device 20. In one example, the control device 10 may store the power capacity that can be supplied in the storage unit 103 in advance for each type of the power supply device 20. In this case, the control device 10 may receive information indicating the type of the power supply device 20 from the power supply device 20 and extract the power capacity that can be supplied stored in the storage unit 103 on the basis of the received type.

At S204, the control device 10 acquires, from the power supply device 20, supply power information regarding the electric power supplied by the power supply device 20. The supply power information includes the identifier of the power supply device 20 and information indicating the power amount (kW) supplied by the power supply device 20. The supply power information includes a voltage value of electric power supplied by each power supply device 20. The control device 10 stores the acquired supply power information. Immediately after starting power supply, each power supply device 20 performs power supply at an initial voltage common in the power supply system 1, for example, 164 V. Thereafter, in a case where the supply voltage is controlled by processing to be described later, the voltage at which power supply is performed is reported. In this processing example, in setting of the initial voltage, the description is given assuming that the supply power information received from each power supply device 20 indicates that the power supply device 20A performs power supply of 2 kW, the power supply device 20B performs power supply of 2 kW at the initial voltage, and the power supply device 20C performs power supply of 1 kW at the initial voltage. Therefore, the supply power information received by the control device 10 from the power supply device 20A at S204 includes information indicating that power supply of 2 kW is performed. Note that, the supply power information at S204 is transmitted from the power supply device 20 to the control device 10 at a predetermined time cycle, for example, a cycle of 30 seconds. As a result, the control device 10 can follow a change in supply power amount of the power supply device 20.

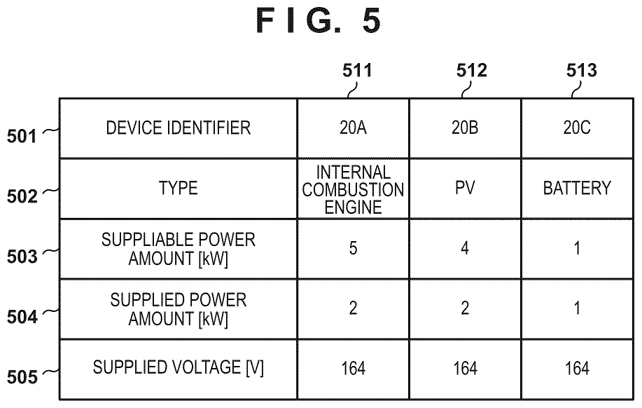

Herein, an example of the profile information and the supply power information stored in the storage unit 103 is described with reference to FIG. 5.

The storage unit 103 stores an identifier 501 of the power supply device 20, a power supply type 502, a power amount that can be supplied 503, a supplied power amount 504, and a supplied voltage value (supply voltage) 505 in association with one another.

For example, as for the power supply device 20A, the control device 10 receives at S203 the profile information indicating that the identifier 501 is “20 A”, the power supply type 502 is “internal combustion engine”, and the power amount that can be supplied 503 is “5 kW”, so that the information is stored in the storage unit 103. When the supply power information indicating that the power amount 504 supplied by the power supply device with the identifier 501 of “20 A” is 2 kW and the supply voltage 505 is 164 V is received at S204, the control device 10 stores the information in the storage unit 103.

At S205, the control device 10 sums up the power capacities that can be supplied by the power supply devices 20 that supply electric power. In this processing example, the power amount that can be supplied by each power supply device 20 is 10 kW.

At S206, the control device 10 determines the power amount to be supplied to the load device 40 or a distribution ratio (target distribution ratio) of the load on the basis of a ratio of the power capacities that can be supplied by the power supply devices 20. In this processing example, it is determined to supply at a distribution ratio of 5:4:1 according to the power capacities that can be supplied by the power supply devices 20A, 20B, and 20 C. That is, it is determined that a target is that the power supply device 20A supplies 50% of an entire supply power of the power supply system 1, the power supply device 20B supplies 40% of the entire supply power, and the power supply device 20C supplies 10% of the entire supply power. In one example, the determined target distribution ratio may be stored in the storage unit 103 in association with the identifier of the power supply device 20.

At S207, the control device 10 specifies the voltage of the supply power of each power supply device 20. Immediately after power supply is started, the control device 10 specifies the voltage of the supply power of each power supply device 20 as 164 V, which is an initial value.

At S208, the control device 10 determines a total amount of supply power by the power supply devices 20 from the supply power information received at S205. In this processing example, it is specified that the power supply device 20A supplies 2 kW, the power supply device 20B supplies 2 kW, and the power supply device 20C supplies 1 kW, that is, a total of 5 kW of electric power is supplied at the above-described initial voltage. In one example, at S208, the control device 10 may acquire the power amount supplied to the load device 40 from the inverter 30, and set the acquired power amount as the total amount of supply power.

At S209, the control device 10 specifies the ratio (distribution ratio) of the electric power supplied by each power supply device 20 to the total amount of the supply power of the power supply devices 20 specified at S208 on the basis of the supply power information received at S204. In the setting of the initial voltage, since power supply is performed at a ratio of 2:2:1, it is specified that the power supply device 20A performs power supply at a ratio of 40%, the power supply device 20B performs power supply at a ratio of 40%, and the power supply device 20C performs power supply at a ratio of 20%. The distribution ratio specified at S209 is stored in the storage unit 103.

At S210, the control device 10 selects one power supply device 20, and acquires a target value (target distribution ratio) of the supply power of the power supply device 20 and a current distribution ratio from the storage unit 103. For example, in the control device 10, the target distribution ratio is 50% and the load distribution ratio is 40% as for the power supply device 20A.

At S211, the control device 10 compares the target distribution ratio of the power supply device 20 selected at S211 with the distribution ratio at the present time, and determines whether the distribution ratio is within a target range (target load range) of the distribution ratio that the power supply device 20 should supply including the target distribution ratio. For example, ±1% of the target distribution ratio is the target load range. As for the power supply device 20 having the target distribution ratio of 50%, the target range is 49 to 51%. In this case, in a case where the distribution ratio is 49% or higher and 51% or lower, it is determined that the distribution ratio is within the target range. In a case where the distribution ratio is lower than 49%, it is determined that the distribution ratio is lower than the target load range. In a case where the distribution ratio is higher than 51%, it is determined that the distribution ratio is higher than the target load range. In a case where the distribution ratio is higher than the target load range (“higher than the target load range” at S211), the control device 10 advances the processing to S212, and transmits the control signal to the power supply device 20 selected at S210 to perform power supply at a lower voltage. As a result, since the power supply device 20 performs power supply at a lower voltage, the electric power supplied by the power supply device 20 decreases, and the distribution ratio of the power amount supplied to the load device 40 can be lowered. In a case where the distribution ratio is lower than the target load range (“lower than the target load range” at S211), the control device 10 advances the processing to S213, and transmits the control signal to the power supply device 20 selected at S211 to perform power supply at a higher voltage. As a result, since the power supply device 20 performs power supply at a higher voltage, the electric power supplied by the power supply device 20 increases, and the distribution ratio can be raised. In a case where a difference between the current distribution ratio and the target distribution ratio is within a predetermined range (“within target range” at S211), the control device 10 advances the processing to S214.

The control signal transmitted to the power supply device 20 at S212 and S213 includes information indicating a difference from the voltage at which the power supply device 20 supplies electric power. Information indicating −0.5 V is included, for example, so that the supply voltage is lowered by 0.5 V at S212, and information indicating +0.5 V is included, for example, so that the supply voltage is increased by 0.5 V at S213. In one example, information indicating a value (for example, 164.5 V) indicating an absolute value of the voltage supplied by the power supply device 20 can be included. In another example, in a case where the voltage supplied by the power supply device 20 is associated with a plurality of stages, for example, information indicating an instruction to raise the supply voltage by one stage or lower the supply voltage by one stage can be included.

In another example, the control device 10 may determine the value of the voltage or a difference in voltage value indicated to the power supply device 20 at S212 and S213 on the basis of the difference between the distribution ratio and the target distribution ratio. For example, in a case where the difference between the distribution ratio of the power amount supplied by the power supply device 20 and the target distribution ratio is +10% or larger, the difference in voltage value indicated to the power supply device 20 is set to −0.5 V, and in a case where the difference between the distribution ratio of the power amount supplied by the power supply device 20 and the target distribution ratio is +5% or larger and smaller than +10%, the difference in voltage value indicated to the power supply device 20 is set to −0.25 V As a result, the distribution ratio of the power amount supplied by the power supply device 20 having a large difference between the distribution ratio of the supplied power amount and the target distribution ratio can be brought closer to the target distribution ratio more quickly.

The voltage value or the difference in voltage value indicated by the control device 10 to the power supply device 20 on the basis of the difference between the distribution ratio of the power amount and the target distribution ratio may be determined by proportional-integral-differential (PID) control. As a result, it is possible to improve followability with respect to the change in supply power amount while preventing unstable power supply by repeating fluctuation of the voltage value of the electric power supplied by the power supply device 20.

When the voltage of the electric power supplied by a predetermined power supply device 20 is significantly different from the voltage of the electric power supplied by other power supply devices 20, the load applied to the predetermined power supply device 20 might increase. For example, in the power supply device 20 having a voltage significantly lower than the voltage of the electric power supplied by the other power supply devices 20, a load may be applied to an insulation circuit because a voltage is applied in a direction in which the current flows backward. Therefore, an upper limit value and a lower limit value may be set to the value of the voltage of the electric power supplied by the power supply device 20. In such a case, the control device 10 may correct the value of the voltage indicated to the power supply device 20 at S212 and S213 so as not to perform power supply at a voltage higher than the upper limit value or a voltage lower than the lower limit value. For example, after determining to lower the supply voltage of the power supply device 20 by 0.5 V at S212, the control device 10 may acquire the voltage value (for example, 163 V) of the electric power currently supplied by the power supply device 20 from the supply power information, and in a case where it is determined that the voltage value is lower than the lower limit (for example, 162.7 V) of the voltage value of the supply power in a case where the voltage value is lowered by 0.5 V, this may indicate to change the voltage of the supply power to, for example, 162.7 V so as not to be lower than the lower limit. As a result, the control device 10 can control the electric power supplied by the power supply device 20 so that the load applied to each power supply device 20 does not increase.

By performing the processing at S211 to S213 on each power supply device 20, the power amount supplied from each power supply device 20 can be controlled by the control device 10.

At S214, the control device 10 determines whether to stop the operation. For example, it is possible to determine that the operation is stopped by determining that there is no need to supply electric power by the power supply device 20, for example, in a case where it is detected that the operation of all the load devices 40 is stopped or in a case where it is detected that all the load devices 40 are disconnected from the power line 2. In another example, the control device 10 may determine to stop the operation in a case of receiving an operation stop instruction from an operator of the power supply system 1. In a case of determining not to stop the operation (NO at S214), the control device 10 returns the processing to S204, and repeats the processing at S204 to S214 for another power supply device 20. As a result, even in a case where the number of load devices 40 connected to the power supply system 1 or power consumption of the load device 40 changes, it is possible to follow the change.

In a case of determining to stop the operation (YES at S214), the control device 10 advances the processing to S215, and transmits a power supply stop request to each power supply device 20. Upon receiving the power supply stop request, the power supply device 20 stops raising the voltage and finishes the power supply to the power line 2.

As described above, according to the power supply system according to this embodiment, the control device 10 acquires the power amount that can be supplied by the plurality of power supply devices 20, and determines the ratio of the electric power that should be supplied by the predetermined power supply device 20 on the basis of the power amount supplied by the predetermined power supply device 20. Then, the supply voltage of the power supply device 20 is changed according to the determined ratio of electric power and the power amount being supplied. As a result, as illustrated in FIG. 4, the ratio of the electric power that the power supply device 20 should supply can be satisfied by making the initial supply voltage constant regardless of the load and varying the voltage by a necessary amount according to the power amount being supplied. Therefore, it is not necessary to make the supply voltage higher than necessary even at a low load, so that the switching loss at a low load can be suppressed. As a result, power conversion efficiency can be improved, and a cost can be reduced by improving an operating time of the power supply system and reducing the number of cooling components accompanying a reduction in heat generation amount.

According to this embodiment, since the control device 10 controls the power supply of the plurality of power supply devices 20, it is possible to reduce a possibility of occurrence of parallel desynchronization associated with a control delay and to supply stable electric power as compared with a case where each power supply device 20 autonomously controls the supply voltage.

### Summary of Embodiment

1. A control device (10) capable of communicating with a plurality of distributed power sources (20) in a power supply system (1) that supplies electric power to a demander (40), the control device comprising:
at least one processor; and
at least one memory storing instructions that, when executed by the at least one processor, cause the at least one processor to function as:
an acquisition unit configured to acquire capability information regarding a capability of power supply of a first distributed power source and supply power information regarding a power amount being supplied by the first distributed power source from the first distributed power source out of the plurality of distributed power sources; (S203, S204)
a determination unit configured to determine a target value of electric power supplied by the first distributed power source on the basis of the capability information acquired by the acquisition unit; (S206) and
a control unit configured to control electric power supplied by the first distributed power source on the basis of the target value determined by the determination unit and the supply power information acquired by the acquisition unit (S212, S213).

As a result, the power supply of the power supply device can be controlled according to the load of the power supply device.

2. The control device according to the above embodiments, wherein
the control unit is configured to control the electric power supplied by the first distributed power source by transmitting a control signal instructing a voltage supplied by the first distributed power source to the first distributed power source.

As a result, the load of the power supply device can be controlled by controlling the voltage of the power supply device.

3. The control device according to the above embodiment, wherein
the control unit is configured to:
instruct, in a case where power amount supplied by the first distributed power source is larger than the target value by a predetermined value or more, to lower the voltage supplied by the first distributed power source, and
instruct, in a case where power amount supplied by the first distributed power source is smaller than the target value by a predetermined value or more, to raise the voltage supplied by the first distributed power source.

As a result, the voltage supplied by the distributed power source can be controlled so as to approach the target load.

4. The control device according to the above embodiments, wherein
the control unit is configured to determine a change amount of the voltage supplied by the first distributed power source by proportional-integral-differential (PID) control.

As a result, it is possible to improve followability with respect to the change in supply power amount while preventing resonance of the supply voltage.

5. The control device according to the above embodiments, wherein
the determination unit is configured to determine the target value of the electric power supplied by the first distributed power source on the basis of a ratio of a power amount that can be supplied by the first distributed power source to a total value of power amounts that can be supplied by each of the plurality of distributed power sources.

As a result, it is possible to equalize the supply power amount with respect to the power amount that can be supplied by the plurality of distributed power sources.

6. The control device according to the above embodiments, wherein
the supply power information includes a current amount and a voltage value measured by a measurement unit comprised in the plurality of distributed power sources, and
the acquisition unit is configured to receives the supply power information transmitted from the plurality of distributed power sources.

As a result, the power supply can be controlled following a change in power amount supplied by the distributed power source.

7. The control device according to the above embodiments, wherein the power supply system performs power supply in a microgrid.

As a result, the power supply of the power supply device can be controlled according to the load of the power supply device in an off-grid state.

8. A power supply system, that supplies electric power to a demander, comprising:
a plurality of distributed power sources; and
a control device capable of communicating with the plurality of distributed power sources,
the control device including:
   an acquisition unit configured to acquire capability information regarding a capability of power supply of a first distributed power source and supply power information regarding a power amount being supplied by the first distributed power source from the first distributed power source out of the plurality of distributed power sources;
   a determination unit configured to determine a target value of electric power supplied by the first distributed power source on the basis of the capability information acquired by the acquisition unit; and
   a transmission unit configured to transmit a control signal that controls electric power supplied by the first distributed power source on the basis of the target value determined by the determination unit and the supply power information acquired by the acquisition unit to the first distributed power source, wherein
the first distributed power source controls an output voltage on the basis of the control signal received from the control device.

As a result, the power supply of the power supply device can be controlled according to the load of the power supply device in the power supply system.

9. A control method executed by a control device capable of communicating with a plurality of distributed power sources in a power supply system configured to supply electric power to a demander, the control method comprising:
acquiring capability information regarding a capability of power supply of a first distributed power source and supply power information regarding a power amount being supplied by the first distributed power source from the first distributed power source out of the plurality of distributed power sources;
determining a target value of electric power supplied by the first distributed power source on the basis of the acquired capability information; and
controlling electric power supplied by the first distributed power source on the basis of the determined target value and the acquired supply power information.

As a result, the power supply of the power supply device can be controlled according to the load of the power supply device.

10. A non-transitory computer readable storage medium storing a program that allows a computer of a control device capable of communicating with a plurality of distributed power sources in a power supply system configured to supply electric power to a demander to execute:
an acquiring step of acquiring capability information regarding a capability of power supply of a first distributed power source and supply power information regarding a power amount being supplied by the first distributed power source from the first distributed power source out of the plurality of distributed power sources;
a determining step of determining a target value of electric power supplied by the first distributed power source on the basis of the capability information acquired in the acquiring step; and
a controlling step of controlling electric power supplied by the first distributed power source on the basis of the target value determined in the determining step and the supply power information acquired in the acquiring step.

As a result, the power supply of the power supply device can be controlled according to the load of the power supply device.

### Other Embodiments

The invention is not limited to the foregoing embodiments, and various variations/changes are possible within the spirit of the invention.

In this embodiment, the description is given assuming that the ratio of the power amount that can be supplied by a predetermined power supply device to the sum of the power amounts that can be supplied by a plurality of power supply devices is set as the target distribution ratio, the ratio of the power amount supplied by the predetermined power supply device to the sum of the power amounts supplied by the plurality of power supply devices is set as the distribution ratio, and the supply power is controlled so as to reduce the difference between the target distribution ratio and the distribution ratio. That is, the example in which the load is equally distributed according to the supply capability in the plurality of power supply devices is described. However, for example, depending on the operation policy of the power supply system, the power amount to be supplied may be set to be as large as possible for a specific power supply device, and the power amount to be supplied may be set to be as small as possible for other power supply devices in some cases. In such a case, for example, the control device 10 may set a target (target load) to supply 80% of the power amount that can be supplied for the power supply device 20 of a specific type 502, and may set a target load to supply 40% of the power amount that can be supplied for the power supply device 20 of another type. In such a case also, the control device 10 can supply electric power with the target load by controlling the supply voltage on the basis of the difference between the target value of the electric power supplied by one power supply device 20 and the power amount being supplied.

What is claimed is:

1. A control device capable of communicating with a plurality of distributed power sources in a power supply system that supplies electric power to a demander, the control device comprising:
at least one processor; and
at least one memory storing instructions that, when executed by the at least one processor, cause the at least one processor to function as:
an acquisition unit configured to acquire capability information regarding a capability of power supply of a first distributed power source and supply power information regarding a power amount being supplied by the first distributed power source from the first distributed power source out of the plurality of distributed power sources;
a determination unit configured to determine a target value of electric power supplied by the first distributed power source on the basis of the capability information acquired by the acquisition unit; and
a control unit configured to control electric power supplied by the first distributed power source on the basis of the target value determined by the determination unit and the supply power information acquired by the acquisition unit.

2. The control device according to claim 1, wherein
the control unit is configured to control the electric power supplied by the first distributed power source by transmitting a control signal instructing a voltage supplied by the first distributed power source to the first distributed power source.

3. The control device according to claim 2, wherein
the control unit is configured to:
instruct, in a case where power amount supplied by the first distributed power source is larger than the target value by a predetermined value or more, to lower the voltage supplied by the first distributed power source, and
instruct, in a case where power amount supplied by the first distributed power source is smaller than the target value by a predetermined value or more, to raise the voltage supplied by the first distributed power source.

4. The control device according to claim 2, wherein
the control unit is configured to determine a change amount of the voltage supplied by the first distributed power source by proportional-integral-differential (PID) control.

5. The control device according to claim 1, wherein
the determination unit is configured to determine the target value of the electric power supplied by the first distributed power source on the basis of a ratio of a power amount that can be supplied by the first distributed power source to a total value of power amounts that can be supplied by each of the plurality of distributed power sources.

6. The control device according to claim 1, wherein
the supply power information includes a current amount and a voltage value measured by a measurement unit comprised in the plurality of distributed power sources, and
the acquisition unit is configured to receive the supply power information transmitted from the plurality of distributed power sources.

7. The control device according to claim 1, wherein
the power supply system performs power supply in a microgrid.

8. A power supply system, that supplies electric power to a demander, comprising:
a plurality of distributed power sources; and
a control device capable of communicating with the plurality of distributed power sources,
the control device including:
an acquisition unit configured to acquire capability information regarding a capability of power supply of a first distributed power source and supply power information regarding a power amount being supplied by the first distributed power source from the first distributed power source out of the plurality of distributed power sources;
a determination unit configured to determine a target value of electric power supplied by the first distributed power source on the basis of the capability information acquired by the acquisition unit; and
a transmission unit configured to transmit a control signal that controls electric power supplied by the first distributed power source on the basis of the target value determined by the determination unit and the supply power information acquired by the acquisition unit to the first distributed power source, wherein
the first distributed power source controls an output voltage on the basis of the control signal received from the control device.

9. A control method executed by a control device capable of communicating with a plurality of distributed power sources in a power supply system configured to supply electric power to a demander, the control method comprising:
acquiring capability information regarding a capability of power supply of a first distributed power source and supply power information regarding a power amount being supplied by the first distributed power source from the first distributed power source out of the plurality of distributed power sources;
determining a target value of electric power supplied by the first distributed power source on the basis of the acquired capability information; and
controlling electric power supplied by the first distributed power source on the basis of the determined target value and the acquired supply power information.

10. A non-transitory computer readable storage medium storing a program that allows a computer of a control device capable of communicating with a plurality of distributed power sources in a power supply system configured to supply electric power to a demander to execute:
an acquiring step of acquiring capability information regarding a capability of power supply of a first distributed power source and supply power information regarding a power amount being supplied by the first distributed power source from the first distributed power source out of the plurality of distributed power sources;
a determining step of determining a target value of electric power supplied by the first distributed power source on the basis of the capability information acquired in the acquiring step; and
a controlling step of controlling electric power supplied by the first distributed power source on the basis of the target value determined in the determining step and the supply power information acquired in the acquiring step.
